(19) United States
(12) Patent Application Publication
(10) Pub. No.: US 2016/0060911 A1
(43) Pub. Date: Mar. 3, 2016

(54) Apparatus for a Door Locking Module

(71) Applicant: Bendix Commercial Vehicle Systems LLC, Elyria, OH (US)

(72) Inventors: Jeffrey J Krause, Wellington, OH (US); Erich W. Papesch, North Ridgeville, OH (US); Cho-Fai Kwan, Olmsted Falls, OH (US)

(73) Assignee: Bendix Commercial Vehicle Systems LLC, Elyria, OH (US)

(21) Appl. No.: 14/472,833

(22) Filed: Aug. 29, 2014

(51) Int. Cl. E05B 85/00

(52) U.S. Cl. CPC E05B 85/00

(57) ABSTRACT

Various example embodiments of a door locking module are disclosed. In accordance with one aspect, the door locking module comprises a door movement assembly and a locking mechanism. The door movement assembly includes a first linkage, the first linkage including a notch and movable along a first plane. The locking mechanism is operably coupled to the door movement assembly. The locking mechanism comprises a pin movable through the notch from an unlocked position to a locked position, wherein the first linkage is movable along the first plane when the pin is in the unlocked position and the pin prohibits movement of the first linkage along the first plane when the pin is in the locked position.

### BACKGROUND

The present invention relates to a door locking module. Buses, such as school buses, have complex, multipart bilateral door opening mechanisms. Utile door opening mechanism is air actuated, the doors can be opened easily if there is no air in the system to hold the doors closed. Since buses are often parked outside in isolated areas, a reliable means for locking the doors after the driver exits the vehicle is necessary to prevent break-ins and vandalism. In some vehicles, a door opening mechanism may be separate from a door locking mechanism, creating assembly and reliability issues. There is a need for an improved door locking module.

### SUMMARY

Various examples of an apparatus for a door locking module are disclosed. In accordance with one aspect, the door locking module comprises a door movement assembly and a locking mechanism. The door movement assembly includes a first linkage, the first linkage including a notch and the first linkage is movable along a first plane. The locking mechanism comprises a pin movable through the notch from an unlocked position to a locked position, wherein the first linkage is movable along the first plane when the pin is in the unlocked position and the pin prohibits movement of the first linkage along the first plane when the pin is in the locked position.

In accordance with another aspect, a door locking module comprises a door movement assembly and a locking mechanism. The door movement assembly comprises a first linkage, which includes a notch and the first linkage is movable along a first plane, a pivot shaft, the pivot shaft operatively connected to the first linkage and rotatable on a first axis; a second linkage operatively connected to the pivot shaft and movable along a second plane different than the first plane; and a door actuator operatively connected to the second linkage. The locking mechanism comprises a locking actuator; and a pin, the pin operatively connected to the locking actuator, the pin movable through the notch in the first linkage from an unlocked position to a locked position, wherein the pin prevents movement of the first linkage along the first plane when the pin is in the locked position.

### BRIEF DESCRIPTION OF THE DRAWINGS

In the accompanying drawings which are incorporated in and constitute a part of the specification, embodiments of the invention are illustrated, which, together with a general description of the invention given above, and the detailed description given below, serve to exemplify the embodiments of this invention.

FIG. 1 is a side view of a door locking module according to an example embodiment of the present invention;

FIG. 2 is a schematic illustration of the locking pin, according to an example embodiment of the present invention;

FIG. 3 is a top view illustration of the first linkage of the door locking module system of FIG. 1, according to an example embodiment of the present invention;

FIG. 4 illustrates the locking pin in an unlocked position, according to an example embodiment of the present invention; and

FIG. 5 illustrates the locking pin in a locked position, according to an example embodiment of the present invention.

### DETAILED DESCRIPTION

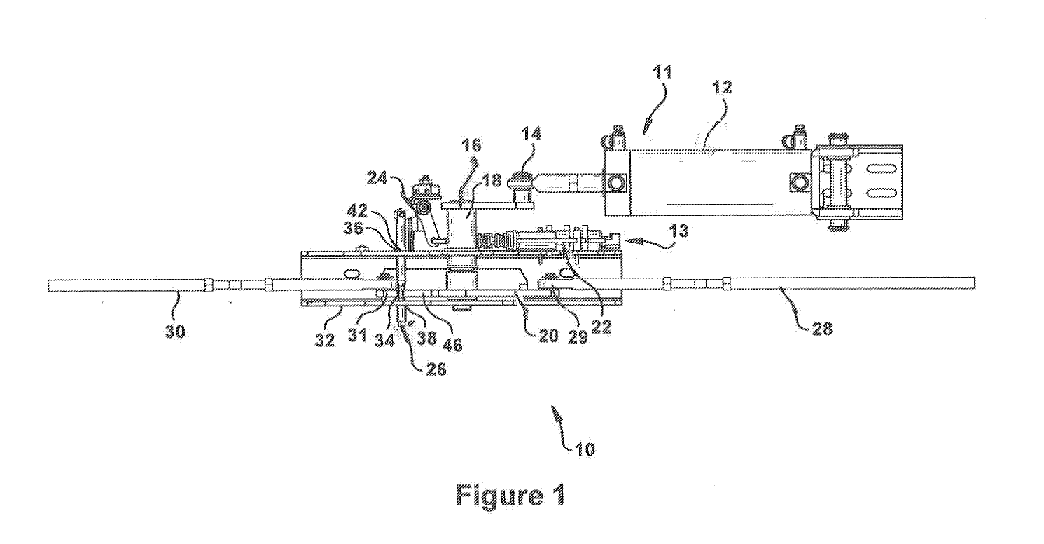

With reference to FIG. 1, a door locking module 10 for locking a door on a vehicle, such as a bus, is shown. The module 10 comprises components of a door movement assembly 11 and a locking mechanism 13. The module 10 can be installed on buses or other commercial vehicles where it is desired to integrate the locking mechanism with the door movement assembly. While the examples explained herein relate to a vehicle door, it is understood that the door locking module can be used in alternative applications.

The components of the door movement assembly 11 include a first linkage 20. The first linkage 20 includes a notch 34. In one example, notch 34 is an arcuate opening along an outer edge 46 of the first linkage 20, although notch 34 can have a variety of cross-sectional shapes. The first linkage includes tie bar pins 29, 31 and the first linkage 20 is operatively connected to tie bars 28, 30 at the tie bar pins 29, 31. The tie bars 28, 30 are connected to the doors of the vehicle (not shown). The first linkage 20 is movable in a first plane A-B.

A pivot shaft 18 is operatively connected to the first linkage 20 at a generally central point. The pivot shaft 18 rotates on an axis Z perpendicular to the first plane A-B of the first linkage 20. The pivot shaft 18 is operatively connected to a first end of a second linkage 16. The second linkage 16 is movable in a second plane C-D parallel to the first plane A-B of the first linkage 20.

A fixed pin 14 is operatively connected to a second end of the second linkage 16. The fixed pin 14 is operatively connected to a door actuator 12. In one example, the door actuator 12 is a pneumatic actuator. In another example, the door actuator 12 is an electric actuator. In another example, the door actuator 12 is a manually actuated device. The door actuator 12 exerts linear motion when actuated, which is converted to rotational motion through the fixed pin 14, the second linkage 16, the pivot pin 18 and the first linkage 20. The tie bars 28, 30 are moved in a direction to open the doors when the door actuator 12 is actuated. The tie bars 28, 30 are moved in a direction to close the doors when the door actuator 12 is deactivated.

in another example, the door movement assembly 11 includes a mounting bracket 32. The components of the door movement assembly 11 are operably coupled to the vehicle via the mounting bracket 32. The mounting bracket 32 eases installation of the module 10 onto the vehicle so that the components of the door movement assembly 11 and locking mechanism 13 are already in alignment.

The components of the locking mechanism 13 include a locking actuator 22. In one example, the locking actuator 22 is an electric actuator. The locking actuator 22 is electrically connected to a driver input device (not shown) to actuate and deactivate the locking actuator 22. The locking actuator 22 is attached to the mounting bracket 32.

The locking actuator 22 is operatively connected to a locking bellcrank 24. A locking pin 26 is operatively connected to the locking bellcrank 24. The locking pin 26 is movable through the notch 34 of the first linkage 20. The locking bellcrank 24 translates the linear motion of the locking actuator 22 to move the locking pin 26 in a direction perpendicular to the first plane A-B of the first linkage 20. The locking actuator 22 moves the locking pin 26 from an unlocked position to a locked position when actuated. In FIG. 1, the locking pin 26 is in the unlocked position.

The locking pin 26 passes through two concentric holes 36, 38 in the mounting bracket 32. The mounting bracket 32 concentric holes 36, 38 confine the motion of the locking pin 26 in a direction that is perpendicular to the first linkage 20 along axis Y. The locking pin 26 is fitted with at least one clip 42. In the example shown in FIG. 1, a first clip 42 is affixed at an upper end of the locking pin 26. For example, the first clip 42 is shaped like the letter “e.” The first clip 42 limits the motion of the locking pin 26 through the mounting bracket 32, thereby keeping the locking and unlocking features in alignment with the first linkage 20. In another example, a second clip (not shown) is affixed to a lower end of the locking pin 26 after the locking pin 26 passes through the concentric holes 36, 38. The second clip prevents the locking actuator 22 from pulling the locking pin 26 up too far out of the mounting bracket 32. The first clip 42 and the second clip assist in retaining the locking pin 26 in the proper position and improve rigidity of the entire locking mechanism 13. The tolerance of the movement of the locking pin 26 is held by the first clip 42 and the second clip instead of by the accuracy of the movement of the locking actuator 22.

Therefore, in one example of the present invention, the door locking module includes a door movement assembly and a locking mechanism. The door movement assembly includes a first linkage; the first linkage includes a notch and is movable along a first plane. The locking mechanism is attached to the mounting bracket and operably coupled to the door movement assembly. The locking mechanism comprises a pin movable through the notch from an unlocked position to a locked position, wherein the first linkage is movable along the first plane when the pin is in the unlocked position and the pin prohibits movement of the first linkage along the first plane when the pin is in the locked position.

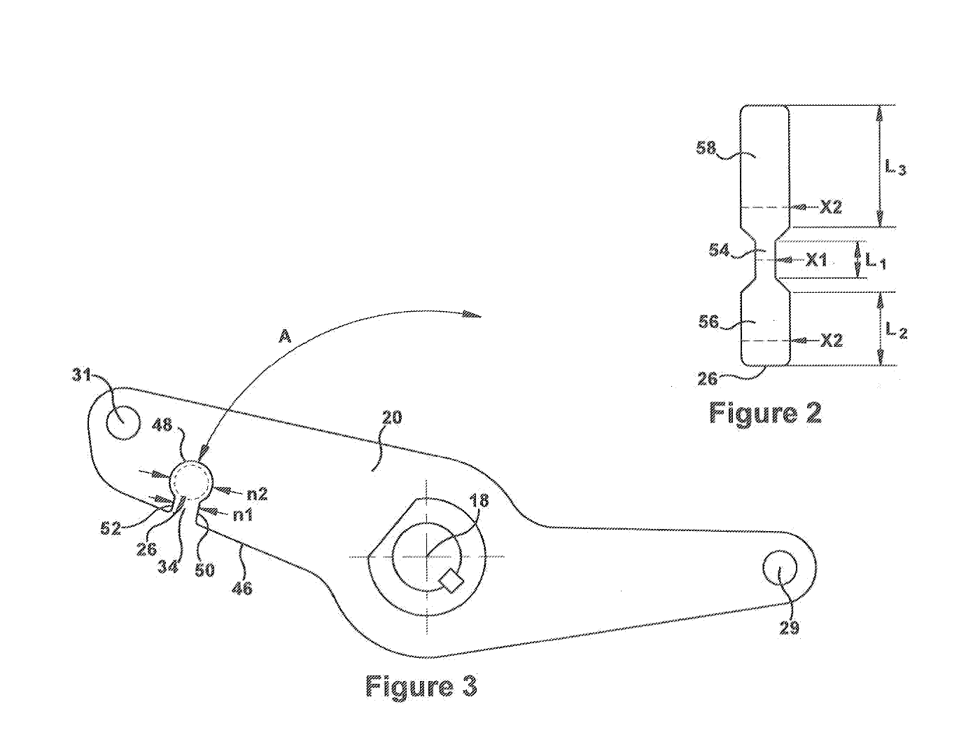

FIG. 2 shows an example of locking pin 26. The locking pin 26 has a first lineal dimension X₁ at a first portion 54 and a second lineal dimension X₂ at a second portion 56, where dimension X₁ is smaller than dimension X₂. in one example, the lineal dimension X₁ ranges from about 0.05 inch to about 0.15 inch, and the lineal dimension X₂ranges from about 0.25 inch to about 0.75 inch. In another example, the lineal dimension x1 is about 0.25 inches and the lineal dimension X₂ is about 0.375 inches. In another example, the lineal dimension X₂ is about 1.5 times the lineal dimension X₁. in one example, the lineal dimension X₁ is a diameter. In one example, the length L₁ of the portion of the locking pin 26 with the lineal dimension X₁ is about 0.50 inches. In another example, the length L₁ is approximately the same as the thickness of the first linkage 20.

In the example shown in FIG. 2, the locking pin 26 is an hour glass shape such that the first portion 54 with length L₁ is between the second portion 56 with length L₂ and a third portion 58 with length L₃. The second portion 56 and the third portion 58 have the same lineal dimension X₂ or may have different lineal dimensions and L₂ and L₃ may be the same dimension or have different dimensions. In the example, an approximate 15 degree taper exists between the lineal dimension X₁ of the first portion 54 and lineal dimension X₂ of the second portion 56 and the third portion 58. In one example, the locking pin 26 is substantially cylindrical with two different lineal dimensions. In another example, the locking pin 26 is substantially a rectangular prism with at least two different lineal dimensions.

The material of the locking pin 26 can be polymer or metal or both. Metals include, but are not limited to, aluminum, steel, zinc, and alloys thereof. In one example the material of the locking pin 26 is a material capable of withstanding shear forces of at least about 200 pounds force; in another example, at least about 300 pounds. The requirements enables the locking pin 26 to withstand shear forces that may be experienced when someone tries to force the doors open when the locking pin 26 is in the locked position.

The dimension X₂ of the locking pin 26 provides alignment to the first linkage 20 when the locking pin 26 is in the locked position as well as the two concentric holes 36, 38 in the mounting bracket 32. The locking pin 26 assists in aligning the door movement assembly 11 and locking assembly 13 to the door frame via the mounting bracket 32 prior to assembly of the door locking module and the setting of the doors.

FIG. 3 shows a top view of the first linkage 20, the tie bar pins 29, 31 and the pivot pin 18. The first linkage 20 moves in clockwise and counterclockwise rotational directions along first plane A-B as the pivot pin 18 rotates. The first linkage 20 receives the locking pin 26 through the notch 34. The notch 34 has an outer portion along edge portion of first linkage 20 with a lineal dimension n1 that is smaller than a notch inner portion having lineal dimension n2. In the example, the notch 34 is substantially a keyhole shape. Wall 48 of the inner portion of the notch 34, formed in the edge 46 of the first linkage 20, is substantially rounded or arcuate while wall 50 and wall 52 of the outer portion of the notch 34, also formed in the edge 46 of the first linkage 20, are substantially parallel. Dimension n1 of the notch 34 is larger than dimension X₁ of the locking pin 26 but is smaller than a maximum dimension of X₂ of the locking pin 26. Dimension n2 of the notch 34 is larger than a maximum dimension of X₂ of the locking pin 26.

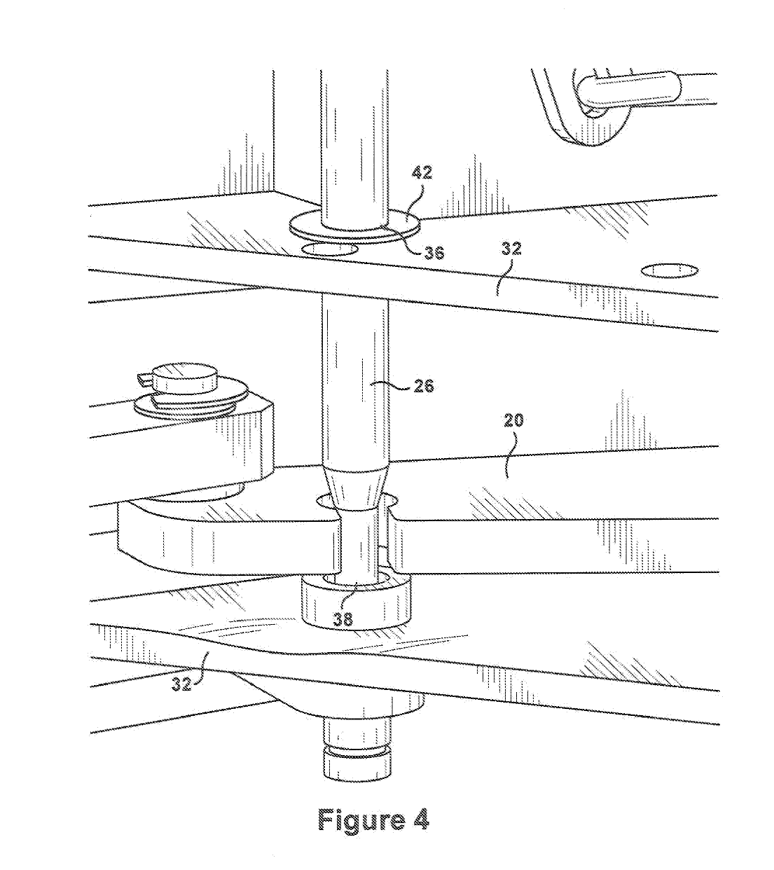

FIG. 4 shows a side view of the first linkage 20 receiving the locking pin 26 where the locking pin 26 is in the unlocked position. In the unlocked position, the first linkage 20 can move in the clockwise direction along the first plane A-B (as shown in FIG. 3) away from the locking pin 26 as the portion of the locking pin 26 with the dimension X₁ is in the same plane as the notch 34. The dimension n1 of the outer portion of the notch 34 is greater than the locking pin dimension X₁ so the first linkage 20 is capable of moving in clockwise direction away from the locking pin 26. As the first linkage 20 moves away from the locking pin 26, the doors are being opened as the tie bars 28, 30 are moved outward in a plane parallel to the first plane A-B. Clip 42 assists in maintaining the dimension X₁ of the locking pin 26 in alignment with the notch 34. The concentric holes 36, 38 in the mounting bracket 32 assist in maintaining the orientation of the locking pin 26 perpendicular to the first plane A-B of the first linkage 20.

FIG. 5 shows a side view of the first linkage 20 receiving the locking pin 26 where the locking pin 26 is in the locked position. The locking pin 26 travels perpendicular to the first linkage 20. The total travel of the locking pin is from about 0.25 inch to about 0.75 inch from the unlocked position to the locked position. In one example, the locking pin 26 travels about 0.50 inches from the unlocked position to the locked position. In the locked position, the first linkage 20 cannot move in a clockwise direction away from the locking pin 26 as the dimension X₂ of the locking pin 26 is in the same plane as the notch 34. The dimension n1 of the notch 34 is less than the dimension K, so that the first linkage 20 cannot move away from the locking pin 26.

In order to operate the module 10, the doors are first closed by deactivating the door actuator 12 or by manual action. This action moves the first linkage 20 to a closed position. In the closed position, the first linkage 20 receives the locking pin 26 such that the dimension X₁ of the locking pin 26 is in the notch 34 of the first linkage 20, as shown in FIG. 4.

To lock the doors using the present locking module 10, the locking actuator 22 is actuated to move the locking pin 26 axially from the unlocked position shown in FIG. 4 to the locked position shown in FIG. 5. In the locked position, the dimension x2 of the locking pin 26 engages the first linkage 20 at the notch 34 as the dimension x2 is now in the same plane as the first linkage 20. Since the dimension x2 of the locking pin 26 is greater than the outer portion dimension n1 of the notch 34, the first linkage 20 is unable to move in rotational direction A to open the doors. The module 10 remains in the locked state until the locking actuator 22 is deactivated,

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

We claim:

1. A door locking module comprising:
a door movement assembly with a first linkage, the first linkage including a notch and the first linkage is movable along a first plane; and
a locking mechanism operably coupled to the door movement assembly, the locking mechanism comprising a pin movable through the notch from an unlocked position to a locked position, wherein the first linkage is movable along the first plane when the pin is in the unlocked position and the pin prohibits movement of the first linkage along the first plane when the pin is in the locked position.

2. The door locking module as in claim 1, wherein a first portion of the pin is in the same plane as the first linkage when the pin is in the unlocked position and wherein a second portion of the pin which has a different dimension than the first section of the pin is in the same plane as the first linkage when the pin is in the locked position.

3. The door locking module as in claim 2, wherein the second portion of the pin has a lineal dimension that is larger than a lineal dimension of the first portion.

4. The door locking module as in claim 2, wherein the first portion and the second portion comprise circular cross-sections and the second portion has a diameter that is larger than a diameter of the first portion.

5. The door locking module as in claim 4, wherein the diameter of the second portion is about 1.5 times the diameter of the first portion.

6. The door locking module as in claim 1, wherein the pin comprises at least a first lineal dimension of a first portion and a second lineal dimension of a second portion, which is different than the first lineal dimension.

7. The door locking module as in claim 6, wherein the notch formed in the first linkage has a shape such that the notch has an opening at an outer portion that is greater than the first lineal dimension of the pin and less than the second lineal dimension of the pin.

8. The door locking module as in claim 6, wherein the first portion of the pin is between the second portion and a third portion of the pin, wherein the second portion and third portion have the same lineal dimension.

9. The door locking module as in claim 1, wherein the pin is a material capable of withstanding shear forces of at least about 200 pounds force.

10. The door locking module as in claim 1, wherein the pin is in an axis that is perpendicular to the first plane.

11. The door locking module as in claim 1, wherein the pin has a total travel of between about 0.25 inches and about 0.75 inches from the unlocked position to the locked position.

12. A door locking module comprising:
a door movement assembly comprising:
a first linkage including a notch and the first linkage movable along a first plane;
a pivot shaft, the pivot shaft operatively connected to the first linkage and rotatable on a first axis;
a second linkage operatively connected to the pivot shaft and movable along a second plane;
a door actuator operatively connected to the second linkage; and
a locking mechanism comprising:
a locking actuator; and
a pin, the pin operatively connected to the locking actuator, the pin movable through the notch in the first linkage from an unlocked position to a locked position, wherein the pin prevents movement of the first linkage along the first plane when the pin is in the locked position.

13. The door locking module as in claim 12, the pin having a first section with a first lineal dimension and a second section with a second lineal dimension, wherein the first section of the pin is in the same plane as the first linkage when in the unlocked position and wherein the second section of the pin is in the same plane as the first linkage when the pin is in the locked position.

14. The door locking module as in claim 13, wherein the second lineal dimension of the pin is greater than the first lineal dimension of the pin.

15. The door locking module as in claim 12, wherein the door actuator is a pneumatic device.

16. The door locking module as in claim 12, wherein the locking actuator is an electrical device.

17. The door locking module as in claim 12, wherein the pin is oriented substantially perpendicular to the plane of the first linkage.

18. The door locking module as in claim 12, further comprising a mounting bracket;
wherein the locking actuator is affixed to the mounting bracket and the door movement assembly is operably coupled to the mounting bracket.

19. The door locking module as in claim 18, wherein the mounting bracket has two concentric holes through which the pin passes, thereby confining the motion of the pin in a direction that is perpendicular to the first linkage.

20. The door locking module as in claim 19, further comprising at least one clip affixed to the pin, the at least one clip limiting the motion of the pin through the mounting bracket.

21. The door locking module as in claim 18, wherein the pin aligns the first linkage to the mounting bracket when the pin is in the locked position.

22. A module for locking a door on a vehicle comprising:
A locking actuator; and
A locking pin, the pin operatively connected to the locking actuator, the pin movable through an associated door movement assembly from an unlocked position to a locked position, wherein the pin prevents movement of the door movement assembly when the pin is in the locked position.
